(19) United States
(12) Patent Application Publication
(10) Pub. No.: US 2004/0088432 A1
(43) Pub. Date: May 6, 2004

(54) Management of attribute data

(76) Inventors: Eric D. Hubbard, Roseville, CA (US); Edward Donald Houston, Roseville, CA (US); Paulene M. Purdy, Roseville, CA (US)

Correspondence Address: HEWLETT-PACKARD COMPANY, Intellectual Property Administration, P.O. Box 272400, Fort Collins, CO, 80527-2400, US

(21) Appl. No.: 10/284,933

(22) Filed: Oct. 31, 2002

(51) Int. Cl. G06F 15/16

(52) U.S. Cl. 709/246

(57) ABSTRACT

A system for managing attribute data provides reference characters to define attribute strings, and thereby provide compressed attribute data. The reference characters may be configured in a tree structure with the reference characters repeatable and configured in parallel resizeable arrays to define attribute data, for example, XML attribute tags. A translation table is provided for use in translating the reference characters associated with the attribute strings. A management server in connection with a user interface provides for management of network resources, including storage devices, associated with the attribute data. The storage devices may be configured to include logical units, with the reference characters repeated and used to represent redundant strings in the different logical units.

### BACKGROUND OF THE INVENTION

A computer network of a business may have multiple storage networks that are located remote from one another and a business user. The storage networks may also be hosted on different types of systems. To perform a job correctly, the business user may require fast and reliable access to the data contained in the storage networks. Information technology (IT) employees must be able to provide high speed, reliable access of the data to the business users, which typically requires constant management of such storage networks, including monitoring the operation of these storage networks and their associated storage devices (e.g., quickly identifying a problem with a particular storage device). Further, access to the storage networks by these IT employees, for example, to resolve problems, must be provided in a reliable and fast manner in order to meet the needs of the business users.

One type of storage network that may be implemented is a storage area network (SAN). A SAN typically provides a high-speed, high-bandwidth inter-server network utilizing integrated hardware (usually fibre channel) and software to provide a robust, high-speed storage backbone. A SAN enables clusters of servers to share storage arrays with exclusive data access or to share data on common storage devices, depending on the particular SAN topology. SAN networks are useful, for example, in fully network enterprises that require storage of substantial amounts of information collected on each customer and each transaction. SANs offer very high-speed, high-availability pools of storage that can be shared throughout an enterprise, yet managed to simplify operations.

SANs provide high-speed transmission of data between interconnected data storage devices, which may be separately controlled by different servers. In a SAN, resources for the particular network are usually spread across a complex network. This requires management of the specific devices, including ensuring proper access to the data contained therein. For example, access to data stored in a particular device may need to be available with limited interruption and/or may be restricted to access by specific groups of users, which may need to be changed periodically.

In order to manage SANs, management of the data contained within the many devices must be provided. As the size of SANs continue to grow, the amount of data that must be managed also grows. Further, each of these devices may include many logical units that are separately accessible. Known SAN management systems typically manage only the devices within the SAN and not the logical units of each of the devices. Further, as the size of SANs increase, with the corresponding number of devices and logical units provided therewith also increasing, memory problems arise (e.g., insufficient memory to manage all the logical units). Compression of the data used for managing these SANs is also known. However, the compression is generic and compresses the data as a whole. Therefore, decompression of the data as a whole is required in order to access the data, thereby resulting in added time and cost to the overall operation.

### SUMMARY OF THE INVENTION

Embodiments of the present invention provides a system and method for managing attribute data associated with one or more storage devices, which devices may be configured, for example, as a SAN. The invention allows for improved access (e.g., faster access) to compressed data (e.g., compressed attribute Extensible Markup Language (XML) data for logical units) stored within the storage devices.

Specifically, in one embodiment of the present invention, a method for managing attribute data relating to one or more network resources includes compressing the attribute data associated with the one or more network resources using reference characters representing attribute data strings. The compressing may include configuring attribute data in a tree structure accessible in compressed form and/or representing the attribute data strings using parallel reference characters comprising integer values. The method further may include translating the reference characters to provide the attribute data strings.

In another embodiment of the present invention a method for managing attribute data relating to one or more storage devices includes receiving attribute data relating to the one or more storage devices, assigning reference characters to the attribute data, and configuring a representation of the attribute data using the assigned reference characters for subsequently accessing the attribute data to determine attributes for the one or more storage devices. The configuring may include arranging the reference characters in parallel and corresponding to attribute data strings. The method further may include translating the reference characters to provide the attribute data for access by a user. The one or more storage devices may include one or more logical units with the attribute data associated with the logical units. The method also may include storing the attribute data in a format accessible by a user.

In yet another embodiment of the present invention, a system for managing attribute data includes a controller for receiving attribute data from one or more network resources and compressing the received attribute data using reference characters representing attribute strings accessible in compressed form, and a user interface for accessing the compressed attribute data. The controller may include a translation table for translating the reference characters forming the compressed attribute data for access via the user interface. The reference characters may include integers and the attribute data may include XML data with the translation table providing translation of the integers to XML attribute strings. The system further may include a management server implementing the controller and configured to store the attribute data in a database for access via the user interface.

Further areas of applicability of embodiments of the present invention will become apparent from the detailed description provided hereinafter. It should be understood that the detailed description and specific examples, while indicating the preferred embodiments of the invention, are intended for purposes of illustration only and are not intended to limit the scope of the invention.

### BRIEF DESCRIPTION OF THE DRAWINGS

Embodiments of the present invention will become more fully understood from the detailed description and the accompanying drawings, wherein:

FIG. 1 is a simplified block diagram of a storage area network (SAN) in connection with which embodiments of the present invention may be implemented;

FIG. 2 is a simplified block diagram of a system of an embodiment of the present invention for managing attribute data;

FIG. 3 is a block diagram of a module of an embodiment of the present invention providing a tree structure for managing attribute data;

FIG. 4 is a block diagram showing an exemplary tree structure of an embodiment of the present invention;

FIG. 5 is exemplary attribute data corresponding to the exemplary tree structure of FIG. 4; and

FIGS. 6(a)-6(d) are exemplary screen displays showing attribute data that may be displayed using embodiments of the present invention.

### DETAILED DESCRIPTION OF PREFERRED EMBODIMENTS

The following description of the preferred embodiments is merely exemplary in nature and is in no way intended to limit the invention, its application, or uses. Although embodiments of the present invention are described in connection with managing a particular type of data stored within a particular storage network, they are not so limited, and embodiments of the present invention may be implemented to manage different types of data stored within different storage networks having different network resources.

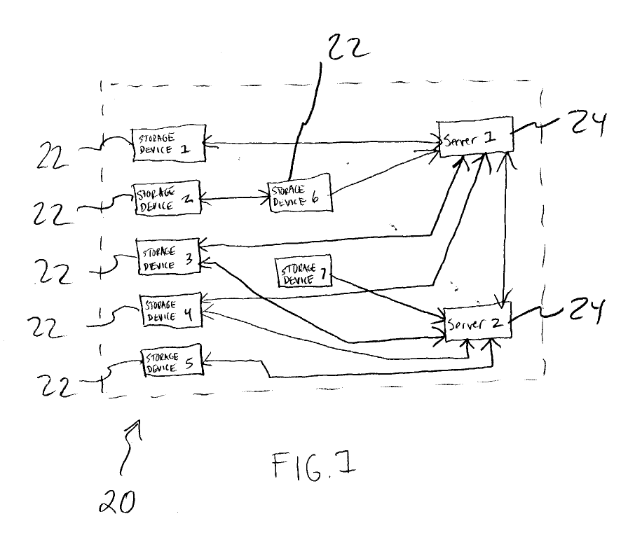

Embodiments of the present invention provide a system and method for managing data in one or more network resources, including one or more devices, and more particularly to managing compressed data in one or more storage devices. For example, embodiments of the present invention may be implemented in connection with a storage area network (SAN) 20 shown in exemplary form in FIG. 1. The SAN 20 typically includes a plurality of storage devices 22 connected to a plurality of network servers 24 for communicating with the plurality of storage devices 22 and accessing the data stored therein. It should be noted that each server 24 may communicate with more than one storage device 22 or may communicate with other servers 24 and in connection with a particular storage device 22. Further, the data stored in connection with each of these storage devices 22 may be organized and/or stored therein as logical units provided as part of these different storage devices 22. The logical units are identified by logical unit numbers (LUNs), which are unique identifiers used on a SCSI bus that provide differentiation between different storage devices 22 and storage therein, and allows for identification of the logical units (e.g., storage space on which a database, a file, an application, etc. is stored) provided as part of these different storage devices 22.

Each of the storage devices 22 typically has associated therewith attribute data regarding the particular storage device 22. This attribute data, may include, but is not limited to, the type and size of the storage device 22, the location of the storage device (e.g. host name and address) on a network (e.g., a SAN), the access and communication requirements of the storage device 22, and the logical units and associated identifying information (e.g., vendor, product identification, serial number, revision, etc. information) for those logical units provided as part of the storage device 22. Thus, this attribute data provides information regarding the storage devices 22, including the logical units contained thereon.

This attribute data may be accessed for use in managing the storage devices 22, particularly when configured as a network (e.g., SAN). The attribute data obtained regarding the storage devices 22 may be stored, for example, as Extensible Markup Language (XML) data, to allow for access to the data independent of an operating platform or language due in part to the language and platform independence of XML. However, because XML data allows for operation (e.g., access) independent of language and platform, it requires additional storage (e.g., memory) to allow for compatibility with the different languages and platforms. Additionally, and with respect to logical units, because typical SANs 20 include many logical units, attribute data provided therewith is often repetitive (e.g., host and LUN entity information used many times). Thus, storage is needed for attribute data relating to these logical units, which may further require compressing the attribute data for storage in memory.

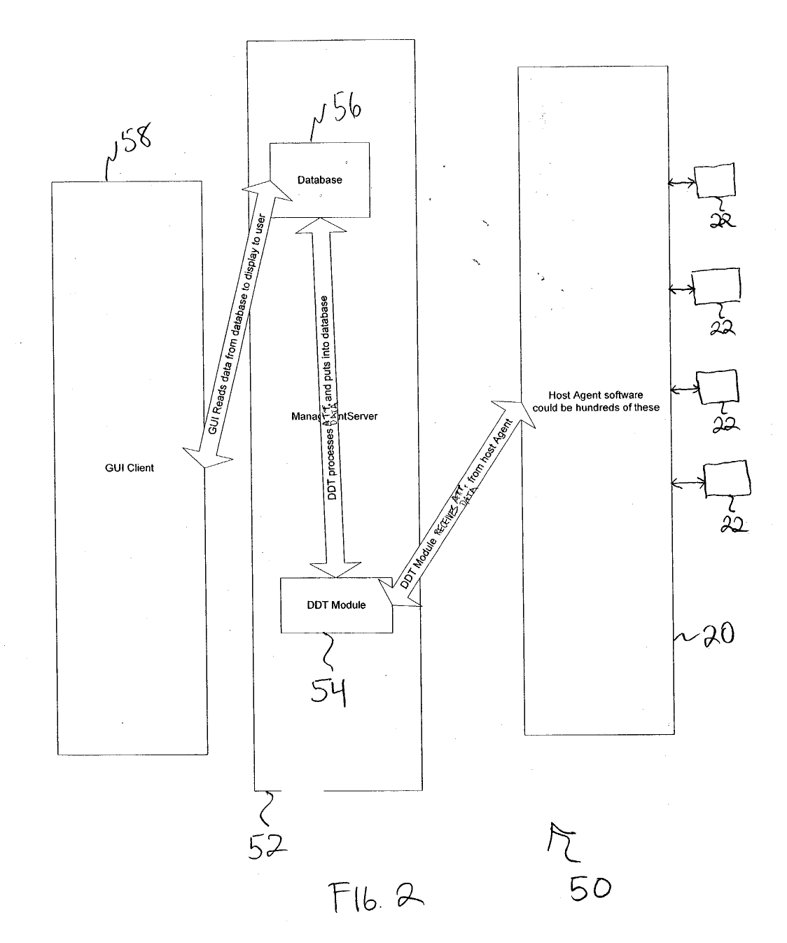

Referring now to FIG. 2, a system 50 constructed according to the principles of an embodiment of the present invention for managing attribute data relating to one more storage devices 22, and more particularly, attribute data relating to logical units of these storage devices 22 is shown therein. For example, and in one embodiment, this attribute data is configured in XML format and accessed in a compressed form. Further, the system 50 reduces redundant attribute data as described in more detail herein. It should be noted that although embodiments of the present invention are described in connection with managing attribute data relating to one or more storage devices, it is not so limited, and embodiments of the present invention may be provided in connection with different devices, including generally any type of network resource. For example, network resources include, but are not limited to, storage devices, peripheral devices such as for example printers, servers, clients, etc.

Specifically, host agents, which in this embodiment are configured as software agents, obtain attribute data from one or more storage devices 22. For example, the host agents may communicate with the storage devices 22, including the logical units of the storage devices 22, using standard SCSI commands (e.g., to provide hardware communication) to obtain the attribute data from the storage devices 22 (e.g., attribute data stored within firmware of the storage devices 22). In this embodiment, the attribute data obtained by the host agents from the storage devices 22 is provided in XML format. It should be noted that the attribute data may be obtained from the storage devices 22 in any known manner and provided in different data formats as needed or desired.

The attribute data is provided to a Management Server 52 that uses references characters and arranges the data using, for example, a tree structure to thereby provide compressed attribute data as described in more detail herein. More particularly, a Device Discovery and Topology (DDT) Module 54 receives the attribute data from the host agents and configures the data for later access in compressed form using reference characters (e.g., integers) with the attribute configured in a tree structure. It should be noted that other component parts, including additional modules may be provided as part of the Management Server 52. For example, components, which may be configured as additional modules, may provide logging facilities to other components and/or scheduling facilities to other components.

The compressed attribute data is stored within memory (e.g., RAM) of the management server 52 and updated based upon attribute data provided from the host agents, for example, on a periodic basis. Further, a database 56 is provided to allow access to the attribute data by users. It should be noted that the attribute stored within the database 56 may be configured in any format, for example, based upon the system used by the user for accessing this data. Further, the attribute data stored with the database 56 may be configured for access, for example, using a series of tables. Further, the data within the database 56 is also updated based upon updated data provided from the host agents. Information in addition to the attribute data also may be stored within the database 56 (e.g., status information relating to a particular device 22).

A graphical user interface (GUI) client 58 is also provided to allow user access (e.g., access by an IT individual) to the attribute data to manage, for example, a SAN 20. The GUI client 58 obtains data from the database 56 for display to a user, for example, on a display of a computer (e.g., on a computer screen).

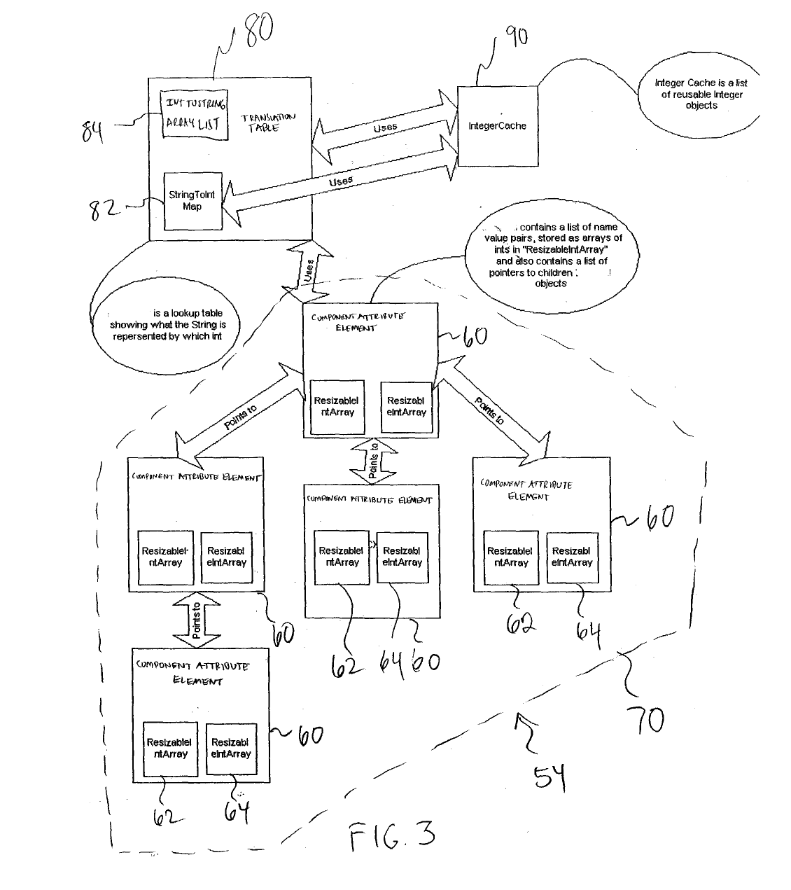

Referring now to the DDT Module 54, and as shown in more detail in FIG. 3, the attribute data is configured as a plurality of sub-segments or classes of attribute data represented by reference characters, and may be configured as a tree structure, with the reference characters used to compress the attribute data. As shown generally therein, the plurality of the sub-segments or classes each define a component attribute element 60 providing attribute data relating to a particular component of the network (e.g., storage device 22, and/or a specific logical unit provided thereon). Each component attribute element 60 includes a first resizeable array 62 and a second resizeable array 64. The first and second resizeable arrays 62 and 64 define the attributes provided by attribute data relating to the component (e.g., specific logical unit) using reference characters (e.g., integers) as described herein.

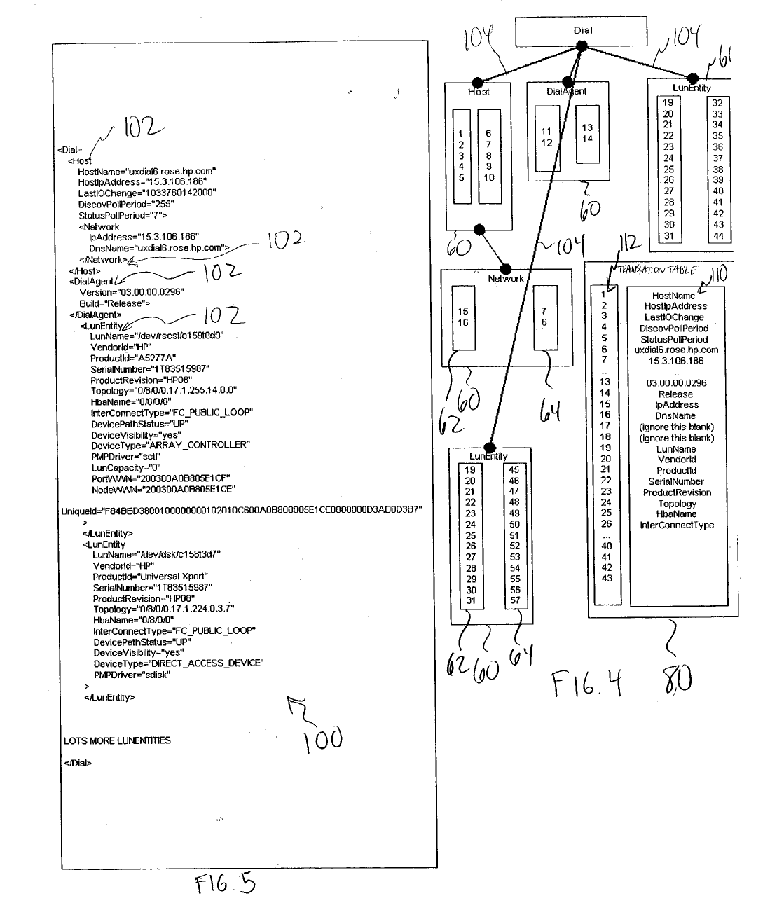

In one embodiment as shown in FIGS. 3 and 4, the component attribute elements 60 are used to organize and/or configure the attribute data in a tree structure 70 with the component attribute elements 60 forming a hierarchical structure (e.g., parent elements pointing to children elements). The component attribute elements 60 also contain a list of pointers 104 that point to other component attribute elements 60 to define the tree structure 70. In one embodiment, the host agents provide attribute data in XML format in a hierarchical structure for use by the DDT module 54 in creating the tree structure 70.

A list of stored reference character pairs (e.g., name integer value pairs) for reducing redundant attribute data are stored as part of the first and second resizeable arrays 62 and 64. In particular, and in one embodiment, attribute strings 110 are represented by integer values 112 defined by a translation table 80 (e.g., a software implemented virtual dictionary). In this embodiment, the translation table 80 includes a String to Integer Map component 82 for mapping attribute strings (e.g., XML strings) to particular integer values, and an Integer to String Array List 84 for determining the attribute strings represented by particular integer values. Further, the translation table 80 communicates with an Integer Cache 90 that provides a list of known reusable Java Integer objects. The Integer Cache 90 allows for integer values in component attribute elements 60 to refer to the same Java Integer objects as needed.

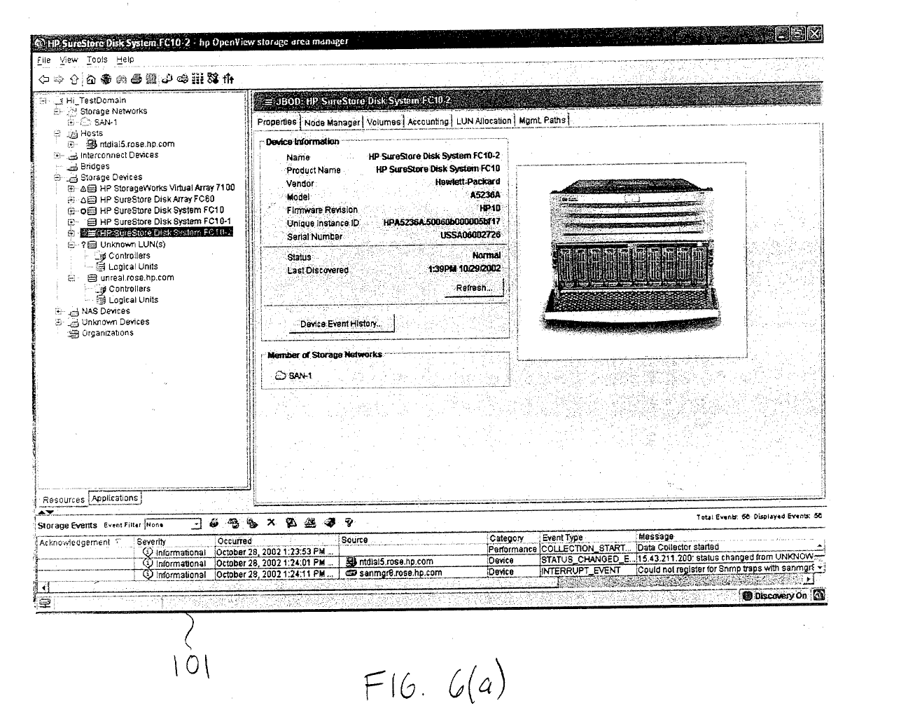

An exemplary tree structure 70 is shown in FIG. 4 based upon exemplary attribute data 100 configured in XML format as shown in FIG. 5. As shown in FIG. 5, the XML data 100 includes a plurality of tags 102 (e.g., host, dial agent, network and LUN entity tags) provided in a nested arrangement, each representing attribute data relating to a component of a storage device 22 (e.g., a logical unit) and/or a component of a network (e.g., host) containing the storage device 22. In XML format, the tags 102 demarcate or identify sub-sections within a hierarchy, which in one embodiment of the invention identifies the different components (e.g., storage devices 22 and/or logical units thereon) and associated attribute data that are each separately represented by a component attribute element 60. Thus, each of these tags 102 is defined by a separate component attribute element 60 as shown in FIG. 4.

In particular, and in one embodiment, each of the component attribute elements 60 define the attributes of a particular tag 102 representing attribute data for a particular component (e.g., logical unit). As shown in FIG. 4, the first and second resizeable arrays 62 and 64, which are preferably configured in parallel arrangement, define each of the attributes of a particular tag 102. For example, in the “Network” component attribute element 60, integer value “15” in the first resizeable array 62 is aligned with integer value “7” in the second resizeable integer array 64. Using the translation table 80 to determine the attribute strings that relate to these integer values, this pair of integer values represent the following attribute of the XML data in FIG. 5: lpAddress=15.3.106.186. It should be noted that attribute strings include attribute identifiers (e.g., LunName identifier for a particular logical unit) and attribute data (e.g., the name of the logical unit corresponding to a LunName).

Thus, compressed attribute data is provided using reference characters (e.g., integers) organized or configured, for example, as the tree structure 70 and defined by the component attribute elements 60 having the first and second resizeable arrays 62 and 64. The tree structure 70 maintains the hierarchy of the attribute data (e.g., XML data strings), which attribute data is provided in compressed form (e.g., reusing integer values, such as “19” identifying LunName, in different component attribute elements 60). No decompression of the attribute data is needed to access and search this data. Translation of the accessed data is provided using the translation table 80. Thus, the attribute data requires less memory for storage because the attributes are not stored as variable length strings, but as fixed length reference characters 112 (e.g., four byte integers).

In operation, the translation table 80 defines attribute strings 110 with corresponding reference characters 112 (e.g., integer values). This allows for repeating particular reference characters 112, thereby reducing the memory required to store the attribute data (e.g., XML data). For example, particular XML strings may be used repeatedly, such as, for example, the integer value “19” to represent the XML string “LunName”. Thus, in one embodiment, attribute information (e.g., device specific description) relating to logical units and LUNs are represented as integer values. Further, the relationship between the various elements (i.e., component attribute elements 60) of the tree structure 70 are maintained using pointers 104 to link the different elements.

Thus, in operation, attribute data, for example logical unit data in XML format is compressed by replacing attribute strings 110, such as XML strings, with reference characters 112, such as integer values, that may be repeatedly used. Specifically, named reference character pairs are stored in parallel arrays (e.g., first and second resizeable arrays 62 and 64) that are accessible in the tree structure 70 format. The first and second resizeable arrays 62 and 64 may be modified to accommodate different size component attribute elements 60 (e.g., tags 102 having different numbers of attributes).

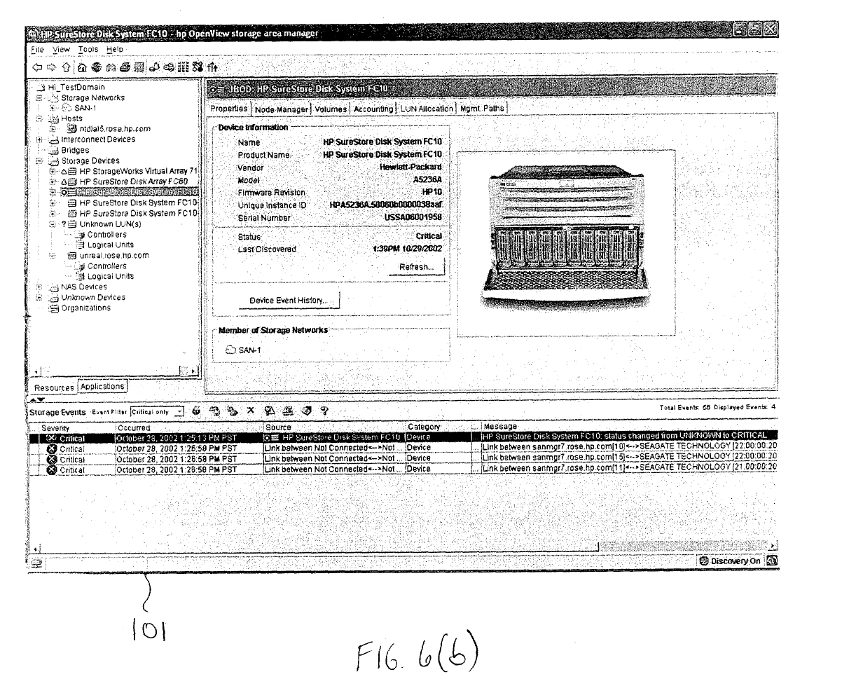

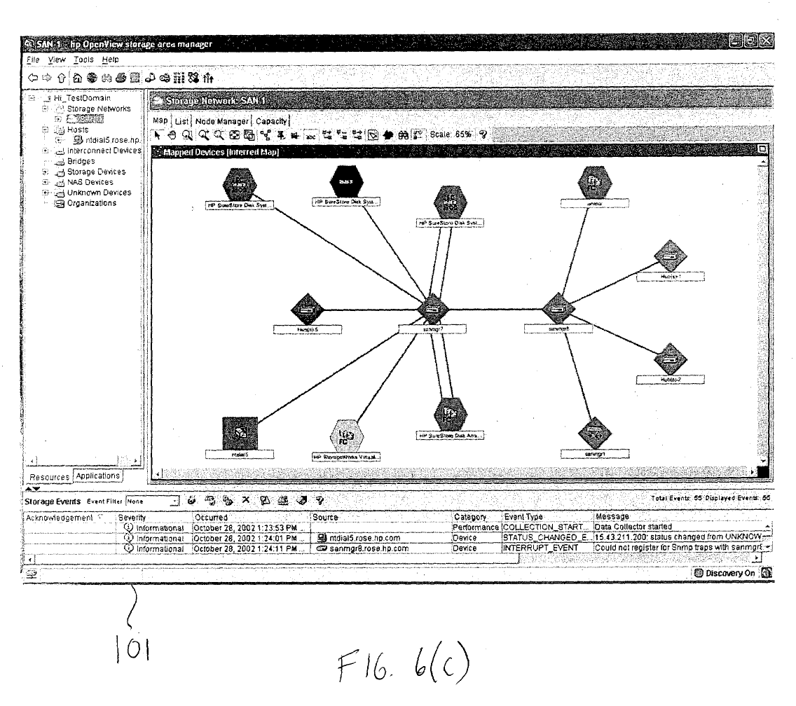

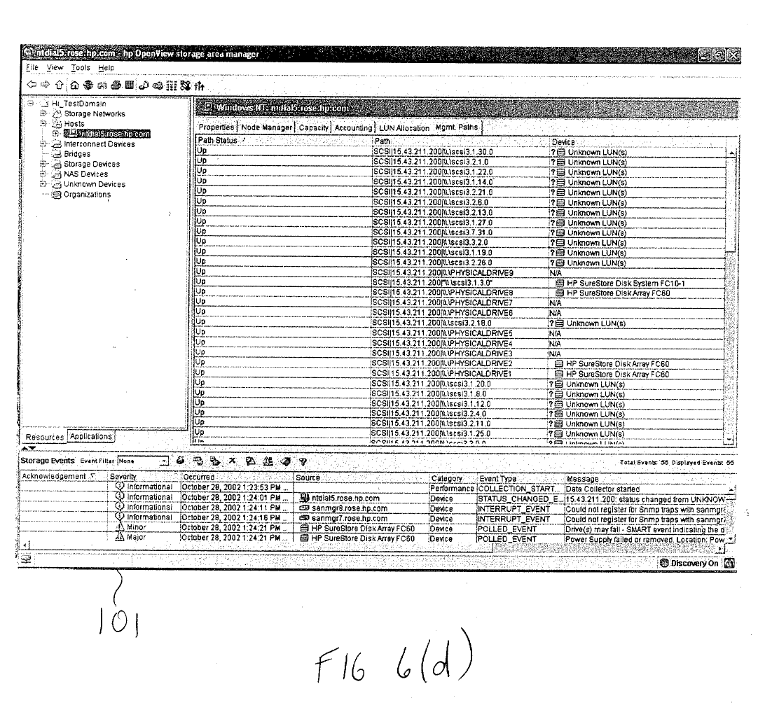

Further, the GUI client 58 may be used as part of a storage area management system for monitoring and changing logical units of storage devices 22 within a SAN 20. For example, the GUI client 58 may be used to display the various hosts and devices 22 within a SAN 20, as well as provide other SAN information (e.g., size of logical units, how the devices 22 are connected, etc.) on a display 101 of a computer as shown in FIGS. 6(a)-6(d), thereby providing a user interface. Further, other functionality may be provided in connection with the GUI client 58. For example, a warning indication (e.g., red light displayed on a GUI) may be provided when a particular storage device 22 fails (e.g., connection fails).

Thus, a system 50 of an embodiment of the present invention provides compressed attribute data (i.e. provided using reference characters 112 that may be organized in a tree structure) that is accessible in the compressed form in memory. The attribute data is also stored within the database 56 and is compared with updated attribute data (e.g., new user rights for a particular logical unit) from the DDT Module 54 received from the host agents, and updated accordingly. The attribute data stored within the database 56, which may be provided in different formats, is accessible for viewing by a user using the GUI client 58.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method for managing attribute data relating to one or more network resources, the method comprising:
compressing the attribute data associated with the one or more network resources using reference characters representing attribute data strings.

2. The method according to claim 1 wherein the compressing comprises configuring attribute data in a tree structure accessible in compressed form.

3. The method according to claim 1 wherein the compressing comprises representing the attribute data strings using parallel reference characters comprising integer values.

4. The method according to claim 2 further comprising linking attribute data relating to components of the one or more network resources to define a relationship forming the tree structure.

5. The method according to claim 4 wherein the attribute data strings comprise XML data, and the components comprise one or more logical units within one or more storage devices.

6. The method according to claim 1 further comprising translating the reference characters to provide the attribute data strings.

7. The method according to claim 1 further comprising updating the compressed attribute data.

8. The method according to claim 1 wherein the attribute data comprises repetitive data.

9. The method according to claim 8 wherein the repetitive data relates to logical unit data.

10. The method according to claim 9, wherein the one or more network resources comprise one or more storage devices and further comprising obtaining data from a plurality of host agents associated with one or more logical units of the one or more storage devices having logical unit data stored therein, the logical unit data provided in XML format.

11. The method according to claim 1 wherein the one or more network resources comprise one or more storage devices configured as a storage area network.

12. A method for managing attribute data relating to one or more storage devices, the method comprising:
receiving attribute data relating to the one or more storage devices;
assigning reference characters to the attribute data; and
configuring a representation of the attribute data using the assigned reference characters for subsequently accessing the attribute data to determine attributes for the one or more storage devices.

13. The method according to claim 12 wherein the configuring comprises arranging the reference characters in parallel and corresponding to attribute data strings.

14. The method according to claim 13 wherein the attribute data comprises attribute identifiers.

15. The method according to claim 12 wherein the attribute data is received in hierarchical order and wherein the configuring comprises arranging the attribute data into a tree structure based upon the hierarchical order.

16. The method according to claim 12 wherein the attribute data comprises XML data.

17. The method according to claim 12 wherein the reference characters comprise integers.

18. The method according to claim 12 further comprising translating the reference characters to provide the attribute data for access by a user.

19. The method according to claim 12 wherein the one or more storage devices comprise one or more logical units and the attribute data is associated with the logical units.

20. The method according to claim 12 further comprising storing the attribute data in a format accessible by a user.

21. A system for managing attribute data comprising:
a controller for receiving attribute data from one or more network resources and compressing the received attribute data using reference characters representing attribute strings accessible in compressed form; and
a user interface for accessing the compressed attribute data.

22. The system according to claim 21 wherein the controller comprises a translation table for translating the reference characters forming the compressed attribute data for access via the user interface.

23. The system according to claim 22 wherein the reference characters comprises integers and the attribute data comprises XML data, and wherein the translation table provides translation of the integers to XML attribute strings.

24. The system according to claim 21 further comprising a management server implementing the controller and configured to store the attribute data in a database for access via the user interface.

25. The system according to claim 21 wherein the one or more network resources comprises one or more storage devices and further comprising one or more host agents for obtaining attribute data from the one or more storage devices.

26. The system according to claim 25 wherein the one or more storage devices comprise one or more logical units and wherein the one or more host agents are configured to obtain attribute data from the one or more logical units.
